(19) United States
(12) Patent Application Publication
(10) Pub. No.: US 2021/0347536 A1
(43) Pub. Date: Nov. 11, 2021

(54) FLEXIBLE PACKAGE ASSEMBLY AND METHOD OF MANUFACTURING

(71) Applicant: Illinois Tool Works Inc., Glenview, IL (US)

(72) Inventors: Christopher Ludwig, Buffalo Grove, IL (US); Beau Brown, Powell, OH (US)

(73) Assignee: Illinois Tool Works Inc., Glenview, IL (US)

(21) Appl. No.: 17/306,436

(22) Filed: May 3, 2021

Related U.S. Application Data
(60) Provisional application No. 63/020,413, filed on May 5, 2020.

(51) Int. Cl. B65D 47/20; B65D 33/16; B65D 75/58; B65D 47/10; B29C 65/08

(52) U.S. Cl. CPC B65D 47/2018; B65D 33/16; B65D 75/5877; B29L 2031/7128; B29C 65/08; B65D 2547/066; B65D 47/10

(57) ABSTRACT

A flexible package assembly may include a pouch configured to hold a fluid, a valve fluidly coupled with the pouch and having an open outlet, the valve defining a conduit through which the fluid may be directed to the open outlet responsive to pressure being applied to the pouch to force the fluid toward the valve. A frangible seal may be disposed between the pouch and the open outlet of the valve or disposed within the valve at the open outlet, the frangible seal may be configured to retain the fluid within the pouch until the frangible seal is broken by the pressure applied to the pouch.

### CROSS-REFERENCE TO RELATED APPLICATIONS

This application claims priority to U.S. Provisional Application Ser. No. 63/020,413 (filed 5-May-2020), the entire disclosure of which is incorporated by reference.

### FIELD

The present disclosure relates to packaging for containing liquids.

### BACKGROUND

Packaging for containing liquids is typically presented in either a rigid or semi-flexible housing. Often, a rigid bottle or semi-flexible tube may be provided with a rigid fitment such as a cap of varying dispense types. In some instances, a flexible pouch may be provided, again having a rigid filament.

When a flexible pouch is provided with a rigid fitment, different manufacturing processes must be used for each component. This adds cost, manufacturing time, and a reduced sustainability profile. Additionally, as e-commerce continues to result in additional shipping, such rigid filaments can unintentionally spill, or dispense liquids within the housing.

### BRIEF DESCRIPTION

In one or more embodiments of the subject matter described herein, a flexible package assembly may be provided that may include a pouch configured to hold a fluid, and a valve fluidly coupled with the pouch and having an open outlet. The valve may define a conduit through which the fluid may be directed to the open outlet responsive to pressure being applied to the pouch to force the fluid toward the valve. A frangible seal may be disposed between the pouch and the open outlet of the valve or disposed within the valve at the open outlet. The frangible seal may also be configured to retain the fluid within the pouch until the frangible seal is broken by the pressure applied to the pouch. Optionally, the frangible seal is disposed between the pouch and the open outlet of the valve or disposed within the valve at the open outlet.

In one or more embodiments of the subject matter described herein, a method may include contacting a first energy director and a second energy director of an ultrasonic welding tool to plural films, the first energy director having a first profile and the second energy director having a second profile that is different from the first profile. The method may also include directing ultrasonic energy into the films through the first energy director and into the films through the second energy director, forming a first interface between the films with the ultrasonic energy that is directed by the first energy director, and forming a second interface between the films with the ultrasonic energy that is directed by the second energy director. The first interface between the films may define a valve having an open outlet that may be fluidly coupled with a pouch configured to hold a fluid, the second interface may be between the films defining a frangible seal between the pouch and the valve. The frangible seal may be configured to retain the fluid within the pouch until the frangible seal is broken responsive to pressure applied to the pouch.

In one or more embodiments of the subject matter described herein, a flexible package assembly may include a pouch configured to hold a fluid, and a valve fluidly coupled with the pouch and having an outlet, the valve defining a conduit through which the fluid is directed to the outlet responsive to pressure being applied to the pouch to force the fluid toward the valve. A frangible seal may be disposed between the pouch and the open outlet of the valve or disposed within the valve at the open outlet, the frangible seal configured to retain the fluid within the pouch until the frangible seal is broken by the pressure applied to the pouch. The valve and the frangible seal may be formed from interfaces between opposing films, the interface forming the valve having a different shape than the interface forming the frangible seal.

### BRIEF DESCRIPTION OF THE DRAWINGS

The present inventive subject matter will be better understood from reading the following description of non-limiting embodiments, with reference to the attached drawings (which are not necessarily drawn to scale), wherein below:

FIG. 1 illustrates a side plan view of a flexible package assembly, in accordance with one or more embodiments of the inventive subject matter described herein;

FIG. 2 illustrates a sectional view of a valve of a flexible package assembly described herein;

FIG. 3 illustrates a schematic view of a flexible package forming assembly as described herein;

FIG. 4 a flowchart of a method of manufacturing a flexible package assembly in accordance with one embodiment;

FIG. 5 illustrates an example energy director of an ultrasonic welding tool;

FIG. 6 illustrates another example of an energy director of the ultrasonic welding tool;

FIG. 7 illustrates another example of an energy director of the ultrasonic welding tool; and

FIG. 8 illustrates another example of an energy director of the ultrasonic welding tool.

### DETAILED DESCRIPTION

This invention is a flexible package assembly that has a flexible valve provided in association with a flexible pouch that is configured to hold fluid. The valve includes a frangible seal that retains fluid within the pouch until a consumer applies enough pressure to break the seal. The flexible valve facilitates the manufacturing process as a result of not needing to retool for a rigid valve. Consequently, manufacturing time and cost are saved. Meanwhile, the frangible seal prevents spilling of the liquid contents in the pouch during delivery and movement of the flexible package assembly to a customer.

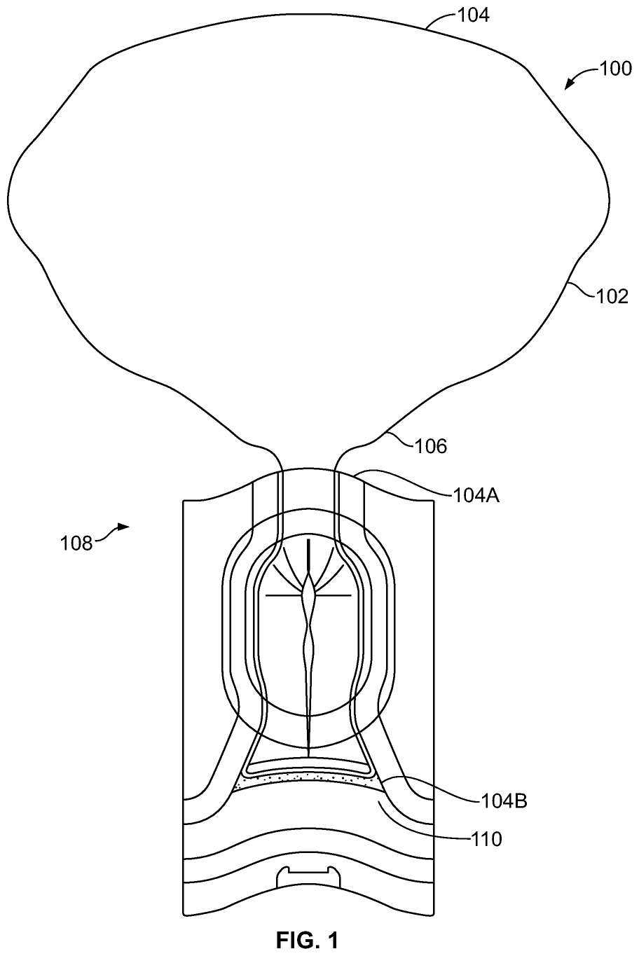

FIG. 1 illustrates a flexible package assembly 100 that may include a pouch 102 that extends from a first end 104 to a second end 106. The pouch 102 may be configured to hold fluid, including liquid, and be formed of a flexible material such as plastic, rubber, ceramic, or the like. In particular, the flexible material may be configured to move, or deflect when pressure is applied to the material.

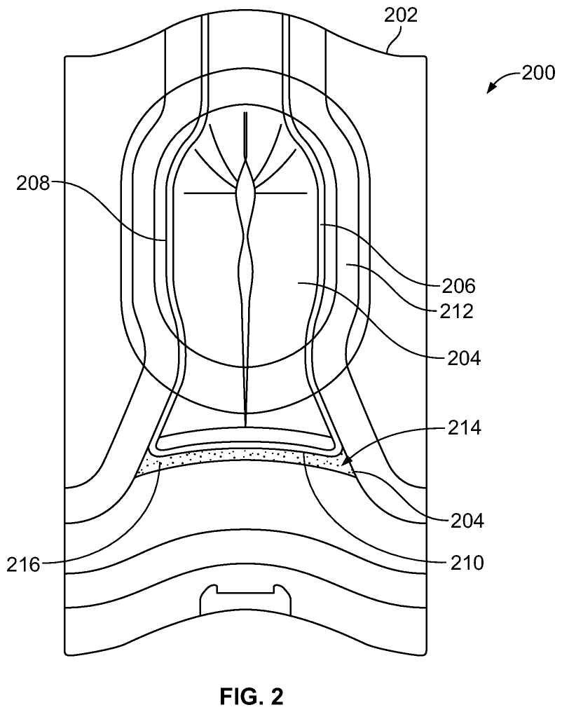

A valve 108 may be provided at one of the first end 109A, or second end 109B of the pouch and include an outlet 110. The valve 108 may be configured to allow the passage of the liquid within the pouch 102 to be disposed therethrough. Similarly, the valve may prevent the passage of liquid therethrough. For example, a frangible seal (FIG. 2) may be provided within the valve 108 to function as a stop, or a dam, to prevent the passage of liquid through the valve 108. Similar to the pouch, the valve 108 may be made of a flexible material, including plastic, rubber, silicone, or the like. The valve 108 may be made of the same material as the pouch 102, or from a different material than the pouch 102. The valve 108 may be formed during the same manufacturing process as the pouch 102, or during a different manufacturing process than the pouch 102. The valve 108 may be formed from a mold, three dimensional printing, an additive process, or the like. Specifically, the valve defines a conduit through which the fluid may be directed to the open outlet 110.

FIG. 2 illustrates a sectional drawing of a valve 200. In one example, the valve 200 is the valve 108 of FIG. 1. The valve 200 extends from a first end 202 to a second end 204. The valve 200 includes a first film 206, and a second film 208 provided in spaced relation, and forming an open outlet 210 therebetween. Specifically, the first film 206 includes a first interface 212 with the opposing second film 208 that forms a valve body 209. Meanwhile, a second interface 214 may be provided as a frangible seal 216 between the opposing first film 206 and second film 208 at the open outlet 210. Specifically, the open outlet 210 may be an exterior opening through which fluid from within a pouch (FIG. 1) is expelled from the valve and remains open before and after the frangible seal 216 is broken.

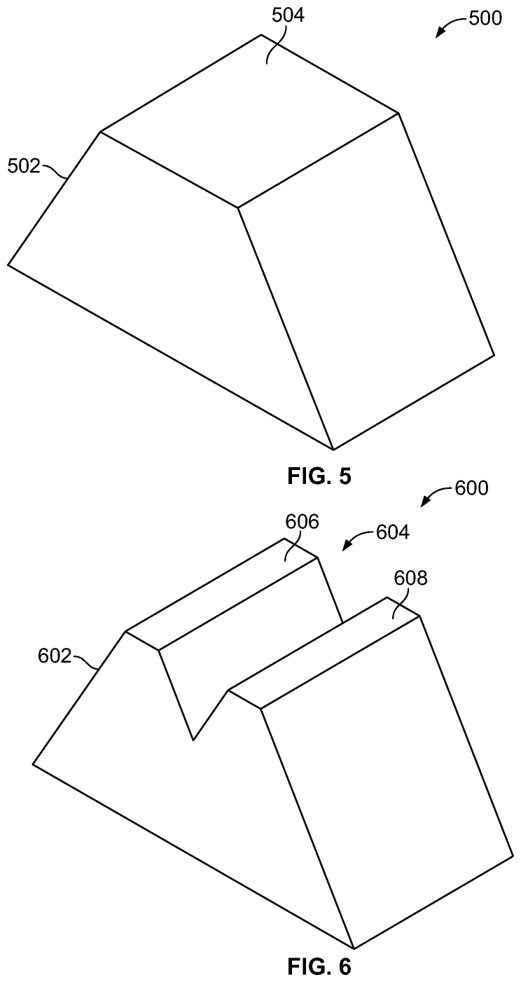

In one example the first interface 212 between the films 206, 208 that form the valve may be larger than the second interface 214 between the films 206, 208 that forms the frangible seal 216. At each interface, a pattern may be provided to secure the first film 206 and second film 208, and the first and second films 206, 208 and frangible seal 216. In particular, FIGS. 5-8 illustrate example patterns that may be provided at an interface 212, 214, though other patterns are contemplated.

In one example, a different pattern may be used to provide a seal for the first interface 212 as compared to the second interface 214. Specifically, the pattern of the first interface 212 between the films 206, 208 may provide a stronger bond, or have a stronger force to pull apart as compared to the pattern of the second interface 214, resulting in the second interface to be easily pealed or broke with pressure that may be provided by a consumer. The patterns of each interface 212, 214 may be formed by altering the energy director profile of an ultrasonic tooling that creates the patterns and valve geometry. In one example a textured, or knurled, pattern may be used on the surface of an energy director. Alternatively, the height of the energy director may be altered. By using the textured pattern, or varying height of the energy director, seal strengths of varying degrees may be accomplished. In this manner, the seal strength of the first interface 212 may be formed to be significantly stronger, or at least five times as strong as the seal strength of the second interface. For example, the interface between the films that form the valve, or first interface 212, may be more rigid than the interface between the films that forms the frangible seal, or second interface 214.

The frangible seal 216 may be disposed along a flow path of fluid from the pouch (FIG. 1), through the valve 200, and out of the outlet 210 of the valve 200. In particular the frangible seal 216 may be disposed between the pouch and the outlet 210 of the valve 200 along the flow path to prevent the flow of liquid from outside the flexible package assembly. By having the frangible seal 216 blocking the flow path, when the flexible package assembly is being transported, before being provided to a user or consumer, liquid from within the flexible package assembly is prevented from leaking or leaving the pouch. Once a user, or consumer has the flexible package assembly, force may be applied to the frangible seal 216 to break the seal, providing access to the pouch via the open outlet 210.

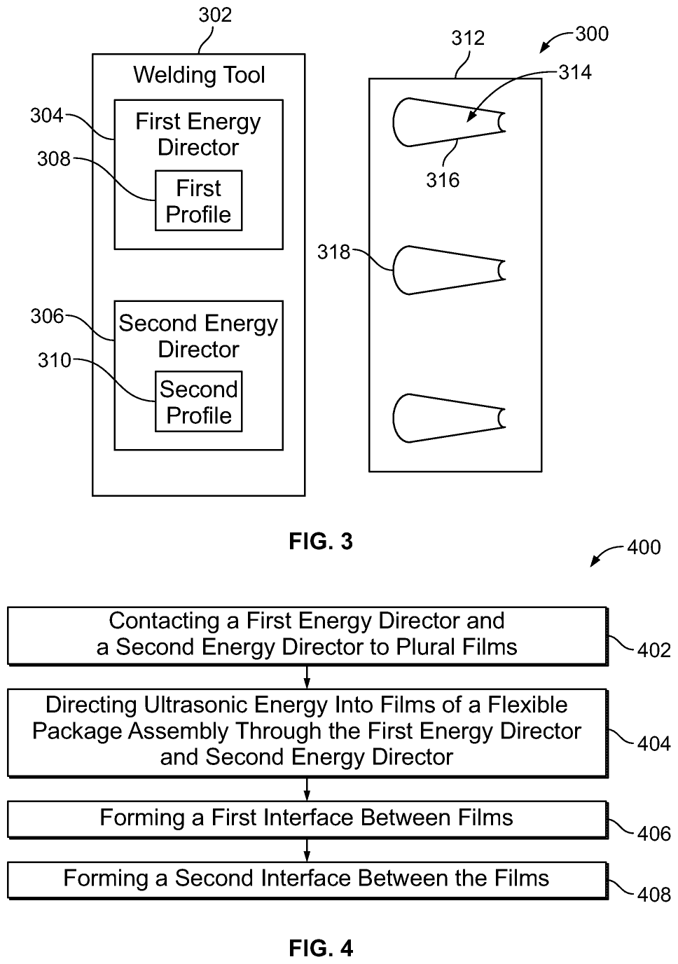

FIG. 3 illustrates a valve forming assembly 300. The valve forming assembly 300 is an example assembly that may be used to form the valve 108 of FIG. 1. The valve forming assembly may include an ultrasonic welding tool 302 that includes a first energy director 304 and a second energy director 306. The first energy director 304 has a first profile 308 and may form a first pattern, while the second energy director 306 may have a second profile 310 that may form a second pattern. In particular, the ultrasonic energy may be directed through the first energy director 304, into films to form a first interface with a first pattern, and ultrasonic energy may be directed through the second energy director 306, into the films to form a second interface with a second pattern.

The first and second patterns of the profiles 308, 310 may include a flat, or two-dimensional profile surface, a three-dimensional profile surface such as any of the patterns illustrated in FIGS. 5-8, or the like. Specifically, the patterns may be altered in dimensions, including seal widths or adding curved surfaces for re-directing molten plastic into patterns as required for the bond strength between film portions. To this end, in one example the width of the first profile 308 may be greater than the width of the second profile 310. In another example, the first profile 308 may be a continuous surface, while the second profile 310 of the second energy director 306 includes island surfaces separated from each other in at least a first direction that is parallel to a surface of the second profile 310 that engages at least one of the films. Alternatively, the island surfaces may be separated from each other in at least first and second orthogonal directions that are parallel to a surface of the second profile 310 that engages at least one of the films. In yet another example, the first profile 308 of the first energy director 304 may be a flat surface and the second profile 310 of the second energy director 306 may include bars that are elongated in a first direction and separated from each other in a second direction that is orthogonal to the first direction.

The valve forming assembly 300 may also include a form 312, that includes a plurality of cavities 314 for forming plural valves. The cavities 314 may be aligned in side-by-side relation to one another, allowing for the ultrasonic welding tool 302 to be used to form plural valves during the manufacturing process. The cavities 314 each receive film that may be modified by the welding tool 302. Specifically, the first profile 308 that has a first pattern may be used to form a first interface 316 while the second profile 310 that has a second pattern may be used to form a second interface 318. The first interface 316 may have a relatively stronger bond than the second interface 318, and in one example is configured to not be removable. Whereas, the second interface 318 may have a relatively weaker bond than the first interface and may be configured to be removable. In one example, the second interface 318 is a frangible seal. By using the different patterns for the different interfaces, a flexible pouch with a flexible valve may be manufactured to encapsulate a liquid without the need for forming a rigid cap.

FIG. 4 illustrates a method 400 for forming a flexible package assembly. In one example, the method 400 may be used to form the flexible package assembly 100 as illustrated in FIG. 1. Similarly, the method 400 may be implemented in one example using the valve forming assembly 300 illustrated in FIG. 3. Optionally, thermal energy (e.g., heat) may be used in place of ultrasonic energy to form the flexible package assembly 100.

At 402, a first energy director and a second energy director of an ultrasonic welding tool may be contacted to plural films. The ultrasonic welding tool in one example may be the ultrasonic welding tool as described in relation to FIG. 3. The first energy director may have a first profile and the second energy director may have a second profile that is different from the first profile. Specifically, the profile may include any profile or pattern discussed, including a flat, or two-dimensional profile surface, a three-dimensional profile surface such as any of the patterns illustrated in FIGS. 5-8, or the like. Specifically, the patterns may be altered in dimensions, including seal widths or adding curved surfaces for re-directing molten plastic into patterns as required for the bond strength between film portions.

At 404, energy may be directed into films of a flexible package assembly. This energy can be ultrasonic energy or thermal energy directed through the first energy director and into the films through the second energy director. The ultrasonic or thermal energy may be provided to melt a pattern into the films.

At 406, a first interface is formed between films with the ultrasonic energy that is directed by the first energy director. The first interface may be formed by providing a pattern within the film with a first energy director having a first profile as described in detail above. In one example, the first interface is bounding the interior of a valve and has a relatively high bond strength to prevent breaking of the bond. Specifically, the first interface between the films may define a valve having an open outlet that is fluidly coupled with a pouch configured to hold a fluid.

At 408, a second interface is formed between the films with the ultrasonic energy that is directed by the second energy director. The second interface may be formed by providing a pattern within the film with a second energy director having a second profile as described in detail above that is different than the first profile. In one example, the first profile results in a pattern that has a relatively greater bond strength than the pattern formed by the second profile. The bond strength of the first pattern may be at least five times greater than the bond strength of the second pattern. Specifically, the second interface between the films may define a frangible seal between the pouch and the valve where the frangible seal may be configured to retain the fluid within the pouch until the frangible seal is broken responsive to pressure applied to the pouch.

FIGS. 5-8 illustrate example energy directors of an ultrasonic welding tool that may be a first energy director or second energy director. To this end, any of the energy directors illustrated in FIGS. 5-8 may be used in the embodiments and method of FIGS. 1-4. Additionally, alternative profiles may be provided, including numerous other three-dimensional profiles, even though not provided in FIGS. 5-8. Specifically, dimensions may be varied, additional curves or patterns may be provided, or the like, to vary the bond strength between two films welded by the ultrasonic welding tool.

FIG. 5 illustrates an example energy director 500. The energy director 500 has a body 502 that is generally trapezoidal in shape. The body 502 includes a profile 504 that represents the active, or heating end of the energy director. In this example, the profile 504 is generally flat continuous surface. In this manner, the profile is considered a two-dimensional profile.

FIG. 6 illustrates an example energy director 600. The energy director 600 has a body 602 that is generally trapezoidal in shape. The body 602 includes a profile 604 that represents the active, or heating end of the energy director. In this example, the profile 604 may include a first island surface 606 and a second island surface 608 separated from each other in at least a first direction that is parallel to a surface of the profile 604 that engages a film. As illustrated, in this example, the profile 604 forms a general V-shape between the first island 606 and second island 608. While illustrate with only two islands, in other examples, additional islands may be added.

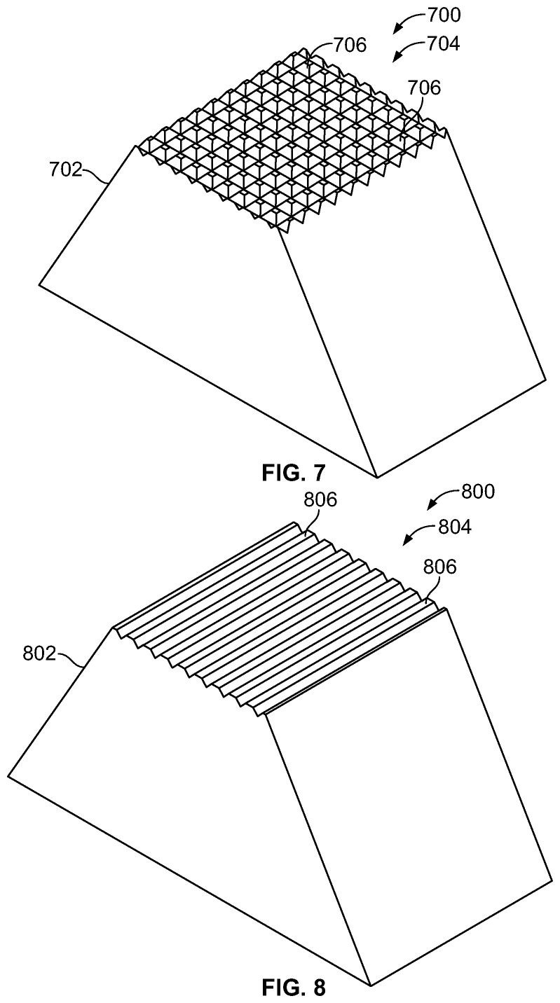

FIG. 7 illustrates an example energy director 700. The energy director 700 has a body 702 that is generally trapezoidal in shape. The body 702 includes a profile 704 that represents the active, or heating end of the energy director. In this example, the profile 704 may include plural island surfaces 706 separated from each other in at least first and second orthogonal directions that are parallel to a surface of the second profile 704 that engages at least one of the films.

FIG. 8 illustrates an example energy director 800. The energy director 800 has a body 802 that is generally trapezoidal in shape. The body 802 includes a profile 804 that represents the active, or heating end of the energy director. In this example, the profile 804 may include plural bars 806 that are elongated in a first direction and separated from each other in a second direction that is orthogonal to the first direction. Each bar is similar to, and can be considered an island as described in relation to FIG. 6.

While FIGS. 5-8 illustrate numerous energy directors, additional profile change may be made to vary the bond strength resulting from the use of an energy director. By providing a first energy director and second energy director with different profiles and bond strengths, a frangible seal may be placed within a flexible valve of a flexible package assembly. As a result, additional tooling for a rigid valve assembly is simply unneeded, saving cost, manufacturing time. In addition, by having a flexible valve assembly, functionality of the flexible package assembly may also be improved.

In one or more embodiments of the subject matter described herein, a flexible package assembly may be provided that may include a pouch configured to hold a fluid, a valve fluidly coupled with the pouch and having an open outlet, the valve defining a conduit through which the fluid may be directed to the open outlet responsive to pressure being applied to the pouch to force the fluid toward the valve, and a frangible seal may be disposed between the pouch and the open outlet of the valve or disposed within the valve at the open outlet, the frangible seal may be configured to retain the fluid within the pouch until the frangible seal is broken by the pressure applied to the pouch.

Optionally, the frangible seal may be disposed along a flow path of the fluid from the pouch, through the valve, and out of the outlet of the valve, the frangible seal disposed between the pouch and the open outlet of the valve or disposed within the valve at the open outlet along the flow path.

Optionally, the open outlet of the valve may be an exterior opening through which the fluid is expelled from the valve and that remains open before and after the frangible seal is broken.

Optionally, the valve and the frangible seal may be formed from interfaces between opposing films.

Optionally, the interface between the films that form the valve may be larger than the interface between the films that forms the frangible seal.

Optionally, the interface between the films that form the valve may have a different pattern than a pattern of the interface between the films that forms the frangible seal.

Optionally, the interface between the films that form the valve may be more rigid than the interface between the films that forms the frangible seal.

In one or more embodiments of the subject matter described herein, a method may including contacting a first energy director and a second energy director of an ultrasonic welding tool to plural films, the first energy director having a first profile and the second energy director having a second profile that is different from the first profile. The method may also include directing ultrasonic energy into the films through the first energy director and into the films through the second energy director, forming a first interface between the films with the ultrasonic energy that is directed by the first energy director, and forming a second interface between the films with the ultrasonic energy that is directed by the second energy director. The first interface between the films may define a valve having an open outlet that may be fluidly coupled with a pouch configured to hold a fluid, the second interface may be between the films defining a frangible seal between the pouch and the valve. The frangible seal may be configured to retain the fluid within the pouch until the frangible seal is broken responsive to pressure applied to the pouch.

Optionally, the first profile of the first energy director may be a flat, two-dimensional profile and the second profile of the second energy director is a three-dimensional profile.

Optionally, the first profile of the first energy director may be wider than the second profile of the second energy director.

Optionally, the first profile of the first energy director may be a continuous surface and the second profile of the second energy director includes island surfaces separated from each other in at least a first direction that is parallel to a surface of the second profile that engages at least one of the films.

Optionally, the first profile of the first energy director may be a continuous surface and the second profile of the second energy director includes island surfaces separated from each other in at least first and second orthogonal directions that are parallel to a surface of the second profile that engages at least one of the films.

Optionally, the first profile of the first energy director may be a flat surface and the second profile of the second energy director includes bars that are elongated in a first direction and separated from each other in a second direction that is orthogonal to the first direction.

In one or more embodiments of the subject matter described herein, a flexible package assembly may be provided that includes a pouch configured to hold a fluid, and a valve fluidly coupled with the pouch and having an outlet, the valve defining a conduit through which the fluid is directed to the outlet responsive to pressure being applied to the pouch to force the fluid toward the valve. A frangible seal may be disposed between the pouch and the open outlet of the valve or disposed within the valve at the open outlet, the frangible seal configured to retain the fluid within the pouch until the frangible seal is broken by the pressure applied to the pouch. The valve and the frangible seal may be formed from interfaces between opposing films, the interface forming the valve having a different shape than the interface forming the frangible seal.

Optionally, the interface between the films that forms the valve may be wider than the interface between the films that forms the frangible seal.

Optionally, the interface between the films that forms the valve may be continuous while the interface between the films that forms the frangible seal is non-continuous.

Optionally, the interface between the films that forms the valve may be formed from a continuous seal between the films while the interface between the films that forms the frangible seal is formed from elongated seals that are elongated in a first direction and spaced apart from each other in a second direction that is orthogonal to the first direction.

Optionally, the interface between the films that forms the valve may be formed from a continuous seal between the films while the interface between the films that forms the frangible seal is formed from island seals that are spaced apart from each other in orthogonal directions.

Optionally, the frangible seal may be disposed along a flow path of the fluid from the pouch, through the valve, and out of the outlet of the valve, the frangible seal disposed between the pouch and the open outlet of the valve or disposed within the valve at the open outlet along the flow path.

Optionally, the outlet of the valve may be an exterior opening through which the fluid is expelled from the valve and that remains open before and after the frangible seal is broken.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed b y a statement of function void of further structure. For example, the recitation of a “mechanism for,” “module for,” “device for,” “unit for,” “component for,” “element for,” “member for,” “apparatus for,” “machine for,” or “system for” is not to be interpreted as invoking 35 U.S.C. § 112(f), and any claim that recites one or more of these terms is not to be interpreted as a means-plus-function claim.

This written description uses examples to disclose several embodiments of the inventive subject matter, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” or “an embodiment” of the presently described inventive subject matter are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

What is claimed is:

1. A flexible package assembly comprising:
a pouch configured to hold a fluid;
a valve fluidly coupled with the pouch and having an open outlet, the valve defining a conduit through which the fluid is directed to the open outlet responsive to pressure being applied to the pouch to force the fluid toward the valve; and
a frangible seal that is one or more of disposed between the pouch and the open outlet of the valve or disposed within the valve at the open outlet, the frangible seal configured to retain the fluid within the pouch until the frangible seal is broken by the pressure applied to the pouch.

2. The flexible package assembly of claim 1, wherein the frangible seal is disposed along a flow path of the fluid from the pouch, through the valve, and out of the open outlet of the valve, the frangible seal disposed between the pouch and the valve along the flow path.

3. The flexible package assembly of claim 1, wherein the open outlet of the valve is an exterior opening through which the fluid is expelled from the valve and that remains open before and after the frangible seal is broken.

4. The flexible package assembly of claim 1, wherein the valve and the frangible seal are formed from interfaces between opposing films.

5. The flexible package assembly of claim 4, wherein the interface between the films that form the valve is larger than the interface between the films that forms the frangible seal.

6. The flexible package assembly of claim 4, wherein the interface between the films that form the valve has a different pattern than a pattern of the interface between the films that forms the frangible seal.

7. The flexible package assembly of claim 4, wherein the interface between the films that form the valve is more rigid than the interface between the films that forms the frangible seal.

8. A method comprising:
contacting a first energy director and a second energy director of an ultrasonic welding tool to plural films, the first energy director having a first profile and the second energy director having a second profile that is different from the first profile;
directing ultrasonic energy into the films through the first energy director and into the films through the second energy director;
forming a first interface between the films with the ultrasonic energy that is directed by the first energy director; and
forming a second interface between the films with the ultrasonic energy that is directed by the second energy director,
wherein the first interface between the films defines a valve having an open outlet that is fluidly coupled with a pouch configured to hold a fluid, the second interface between the films defining a frangible seal between the pouch and the open outlet of the valve, the frangible seal configured to retain the fluid within the pouch until the frangible seal is broken responsive to pressure applied to the pouch.

9. The method of claim 8, wherein the first profile of the first energy director is a flat, two-dimensional profile and the second profile of the second energy director is a three-dimensional profile.

10. The method of claim 8, wherein the first profile of the first energy director is wider than the second profile of the second energy director.

11. The method of claim 8, wherein the first profile of the first energy director is a continuous surface and the second profile of the second energy director includes island surfaces separated from each other in at least a first direction that is parallel to a surface of the second profile that engages at least one of the films.

12. The method of claim 8, wherein the first profile of the first energy director is a continuous surface and the second profile of the second energy director includes island surfaces separated from each other in at least first and second orthogonal directions that are parallel to a surface of the second profile that engages at least one of the films.

13. The method of claim 8, wherein the first profile of the first energy director is a flat surface and the second profile of the second energy director includes bars that are elongated in a first direction and separated from each other in a second direction that is orthogonal to the first direction.

14. A flexible package assembly comprising:
a pouch configured to hold a fluid;
a valve fluidly coupled with the pouch and having an open outlet, the valve defining a conduit through which the fluid is directed to the open outlet responsive to pressure being applied to the pouch to force the fluid toward the valve; and
a frangible seal that is one or more of disposed between the pouch and the open outlet of the valve or disposed within the valve at the open outlet, the frangible seal configured to retain the fluid within the pouch until the frangible seal is broken by the pressure applied to the pouch,
wherein the valve and the frangible seal are formed from interfaces between opposing films, the interface forming the valve having a different shape than the interface forming the frangible seal.

15. The flexible package assembly of claim 14, wherein the interface between the films that forms the valve is wider than the interface between the films that forms the frangible seal.

16. The flexible package assembly of claim 14, wherein the interface between the films that forms the valve is continuous while the interface between the films that forms the frangible seal is non-continuous.

17. The flexible package assembly of claim 16, wherein the interface between the films that forms the valve is formed from a continuous seal between the films while the interface between the films that forms the frangible seal is formed from elongated seals that are elongated in a first direction and spaced apart from each other in a second direction that is orthogonal to the first direction.

18. The flexible package assembly of claim 16, wherein the interface between the films that forms the valve is formed from a continuous seal between the films while the interface between the films that forms the frangible seal is formed from island seals that are spaced apart from each other in orthogonal directions.

19. The flexible package assembly of claim 14, wherein the frangible seal is disposed along a flow path of the fluid from the pouch, through the valve, and out of the open outlet of the valve, the frangible seal disposed between the pouch and the valve along the flow path.

20. The flexible package assembly of claim 14, wherein the outlet of the valve is an exterior opening through which the fluid is expelled from the valve and that remains open before and after the frangible seal is broken.

21. A valve assembly comprising:
a valve configured to be fluidly coupled with a pouch of a flexible package assembly and having an open outlet, the valve defining a conduit through which fluid inside the flexible package assembly is directed to the open outlet responsive to pressure being applied to the pouch to force the fluid toward the valve; and
a frangible seal that is configured to be one or more of disposed between the pouch and the open outlet of the valve or disposed within the valve at the open outlet, the frangible seal configured to retain the fluid within the pouch until the frangible seal is broken by the pressure applied to the pouch.

22. The valve assembly of claim 21, wherein the frangible seal is disposed along a flow path of the fluid from the pouch, through the valve, and out of the open outlet of the valve, the frangible seal disposed between the pouch and the outlet of the valve along the flow path.

23. The valve assembly of claim 21, wherein the open outlet of the valve is an exterior opening through which the fluid is expelled from the valve and that remains open before and after the frangible seal is broken.

24. The valve assembly of claim 21, wherein the valve and the frangible seal are formed from interfaces between opposing films.

25. The valve assembly of claim 24, wherein the interface between the films that form the valve is larger than the interface between the films that forms the frangible seal.

26. The valve assembly of claim 24, wherein the interface between the films that form the valve has a different pattern than a pattern of the interface between the films that forms the frangible seal.

27. The valve assembly of claim 24, wherein the interface between the films that form the valve is more rigid than the interface between the films that forms the frangible seal.
